(19) United States
(12) Patent Application Publication
(10) Pub. No.: US 2026/0295699 A1
(43) Pub. Date: Oct. 1, 2026

(54) METHOD FOR GRINDING A GEAR OR A GEAR-SHAPED PROFILE USING A GRINDING WORM AND DRESSING TOOL

(71) Applicants: KAPP NILES GmbH & Co. KG, Coburg (DE); Volkswagen Aktiengesellschaft, Wolfsburg (DE)

(72) Inventors: Kerstin NIEMANN, Bad Rodach (DE); Andreas FOEHRKOLB, Niederfuellbach (DE); Ludwig PULST, Berlin (DE); Frank GANSERT, Coburg (DE); Maxim KINDSVATER, Wolfsburg (DE); Todor RADEV, Wolfsburg (DE); Stefan HAMMERSCHLAG, Wolfsburg (DE); Georg-Friedrich LUEHRS, Wolfsburg (DE)

(21) Appl. No.: 19/631,317

(22) Filed: Mar. 27, 2026

(30) Foreign Application Priority Data
Mar. 28, 2025 (DE) 10 2025 112 301.2

(51) Int. Cl. B23F 23/12; B23F 1/02

(52) U.S. Cl. CPC B23F 23/1231; B23F 1/023

(57) ABSTRACT

A method for grinding a gear or a gear-shaped profile using a multi-thread grinding worm, in which the grinding worm is subjected to a dressing process prior to grinding, wherein during dressing of the grinding worm a dressing tool is brought into engagement with the grinding worm, wherein the dressing tool is designed as a multi-groove dressing roll which has several dressing surfaces extending around the axis of the dressing roll, which surfaces are tooth-shaped in radial section. In order to make such a method suitable for the economical and highly precise manufacture of gear with a non-equidistant toothing, the invention provides that at least three of the dressing surfaces are unevenly spaced from each other along the axis of the dressing roll and/or that at least two of the dressing surfaces differ from each other in their shape in radial section. Furthermore, the invention relates to a dressing tool.

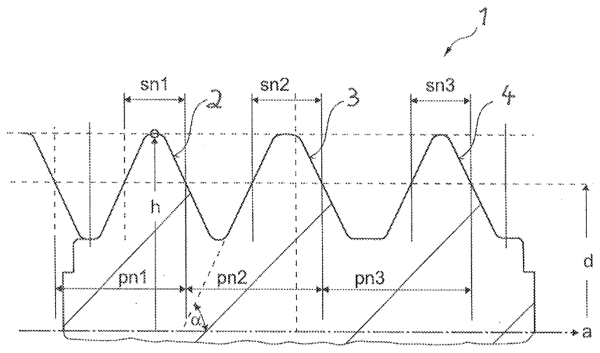

### CROSS-REFERENCE TO RELATED APPLICATIONS

The present application claims priority of DE 10 2025 112 301.2, filed Mar. 28, 2025, the priority of this application is hereby claimed, and this application is incorporated herein by reference.

### BACKGROUND OF THE INVENTION

The invention relates to a method for grinding a gear or a gear-shaped profile using a multi-thread grinding worm, in which the grinding worm is subjected to a dressing process prior to grinding, wherein during dressing of the grinding worm a dressing tool is brought into engagement with the grinding worm, and wherein the dressing tool is designed as a multi-groove dressing roll which has several dressing surfaces extending around the axis of the dressing roll, which surfaces are tooth-shaped in radial section. Furthermore, the invention relates to a dressing tool.

This pre-known process allows gears to be manufactured quickly, economically, and precisely. Grinding with a grinding worm is well known in the prior art, as referred to, for example, in DE 10 2019 004 687 A1, DE 10 2004 020 947 A1, and DE 10 2016 010 893 A1.

The operation of gears inevitably generates noise, which can be minimized by high-quality hard finishing, but can never be completely avoided. Regular noises (noises with a tonal character) are usually perceived as more unpleasant than noises with a noise-like character. In order to reduce the regularity of noise generation in a gear in operation, the use of gears with so-called non-equidistant toothing can be considered. For the state of the art in this regard, reference is made to DE 35 33 743 A1.

Due to the non-equidistant spacing between teeth, the production of such a toothing is more problematic than in the case of classic equidistant toothing. Profile grinding is a suitable hard finishing process for the production of non-equidistant toothings, in which each tooth gap is ground separately for each flank in order to produce the desired non-equidistance.

However, the disadvantage of this method is that it is time-consuming and the gears produced are correspondingly expensive.

### SUMMARY OF THE INVENTION

The invention is based on the object of further developing a method of the type mentioned above in such a way that it is possible to manufacture gears or workpieces with a gear-like profile, which are provided with a non-equidistant toothing or profiling, in an economical manner and with a high degree of precision. Furthermore, a corresponding dressing tool is to be provided.

The solution to this problem provided by the invention is characterized with respect to the method in that, when grinding a gear or a gear-shaped profile with a non-equidistant toothing or profiling by means of a multi-thread grinding worm, at least three of the dressing surfaces are unevenly spaced from each other along the axis of the dressing roll and/or that at least two of the dressing surfaces differ from each other in their shape in radial section.

Preferably, several of the dressing surfaces, preferably all dressing surfaces, are simultaneously engaged with the grinding worm at least temporarily during dressing.

According to a preferred embodiment of the invention, the tooth-shaped dressing surfaces have a tooth thickness at a reference diameter, wherein at least two of the tooth thicknesses are of different in sizes.

In addition or alternatively, it may be provided that the tooth-shaped dressing surfaces have a pitch at a reference diameter, wherein at least two of the pitches are of different sizes.

Another additional or alternative embodiment provides that the tooth-shaped dressing surfaces have a maximum radial height, wherein at least two of the heights are of different sizes.

Another possibility is that the tooth-shaped dressing surfaces have a flank angle, wherein at least two of the flank angles are of different sizes.

Preferably, all tooth thicknesses, all pitches, all heights, and all flank angles are of different sizes.

The difference between the above-mentioned largest and smallest tooth thickness is preferably at least 0.05 mm, particularly preferably at least 0.1 mm, and especially at least 0.2 mm. Accordingly, the difference between the largest and smallest pitch is also preferably at least 0.05 mm, particularly preferably at least 0.1 mm, and especially at least 0.2 mm.

The ratio of the number of teeth of the gear or the gear-shaped profile and the number of threads of the grinding worm to be dressed is preferably an integer.

The proposed dressing tool for dressing a multi-thread grinding worm for grinding a gear or a gear-shaped profile with non-equidistant toothing or profiling, which is designed as a multi-groove dressing roll having several dressing surfaces running around the axis of the dressing roll, which are tooth-shaped in radial section, is characterized according to the invention in that at least three of the dressing surfaces, preferably all dressing surfaces, are unevenly spaced from each other along the axis of the dressing roll and/or that at least two of the dressing surfaces, preferably all dressing surfaces, differ from each other in their shape in radial section.

Otherwise, the above-mentioned specifications regarding the geometric parameters that distinguish the individual dressing surfaces from one another, as well as the aforementioned size ratios, also apply here.

The dressing surfaces preferably have a diamond coating.

The proposed method and design of the dressing roll make it possible to quickly and precisely hard finish gears with non-equidistant toothing.

The core idea behind the invention is that the individual dressing surfaces of the dressing roll are not all identical, but differ in particular in their positions along the direction of the axis of the dressing roll, in terms of tooth thickness, tooth head height, tooth gap base depth, contact angle, gear module, and/or tooth width.

While specific embodiments of the invention have been shown and described in detail to illustrate the inventive principles, it will be understood that the invention may be embodied otherwise without departing from such principles.

### BRIEF DESCRIPTION OF THE DRAWING

In the drawings:

The drawing shows an embodiment of the invention. The only FIGURE shows the radial section (or normal section, i.e., the axis of the dressing roll lies in the drawing plane) through a multi groove dressing roll, which is designed for dressing a multi-thread grinding worm.

### DETAILED DESCRIPTION OF THE INVENTION

The FIGURE shows a dressing tool 1 in the form of a multi-groove dressing roll (or its upper half), which has several dressing surfaces 2, 3, 4 that run parallel to each other circular around the axis a of the dressing roll 1. The dressing surfaces 2, 3, 4 are coated with diamond and are thus able to provide the individual threads of the grinding worm with the profile specified by the dressing surfaces 2, 3, 4 of the dressing roll 1 when engaging with a grinding worm to be dressed.

It is not further explained that the appropriately dressed grinding worm is then used to perform hard finishing on a gear toothing using the generating grinding method, which is well known in the prior art.

It is essential that the three dressing surfaces 2, 3 and 4 are not all geometrically identical, but are arranged along the axis a of the dressing roll 1 with different or varying pitches.

If one considers a reference diameter d (which in this case lies approximately midway between the head circle and the foot circle of the tooth-shaped design shown), the respective values sn1, sn2, and sn3 result for the tooth thicknesses. It is essential that, according to a preferred embodiment of the invention, different values are available for the tooth thicknesses, i.e., in contrast to previously known solutions, the tooth thicknesses are not all the same.

Correspondingly, in the embodiment the pitches (i.e., the distances from tooth to tooth) pn1, pn2, and pn3 are also different and, unlike in previously known solutions, are not all the same. The radial height h is also marked for one of the dressing surfaces (namely for dressing surface 2). In the embodiment, the radial heights h of all dressing surfaces 2, 3, and 4 are the same; however, it is also possible to vary the heights.

The same applies to the flank angle α of the flanks of the dressing surfaces 2, 3, 4; this is marked for dressing surface 3. Here too, the angles as shown in the embodiment are all the same size. However, it is also possible to provide different angles for the individual dressing surfaces 2, 3, 4.

If a multi-thread grinding worm is dressed using such a dressing roll, it is profiled in such a way that, when the toothing is subsequently ground with the grinding worm, the result is a non-equidistant gearing, i.e., the tooth thicknesses, pitches, and other geometric dimensions are not all the same, but vary.

With regard to the above-mentioned magnitudes of the differences between the largest and smallest tooth thickness and between the largest and smallest pitch, it should be noted that these result in an offset in the pitch of the gear teeth of approximately 0.5° when grinding a toothing with the grinding worm that is dressed with the dressing roll 1. This then results in the characteristic of the non-equidistant toothing.

The pre-profiling of the grinding worm (from a cylindrical base body), i.e. the initial introduction of the individual worm threads of the grinding worm, can be carried out on a profiling machine (e.g. from Burri Werkzeugmaschinen GmbH und Co. KG). Here, the individual worm threads can be machined on both flanks using a diamond disc. Furthermore, each individual thread of the grinding worm can be machined with an individual profile depth and/or with an individual rotary and/or tangential position and/or with an individual flank angle (each with a constant pitch). The described method then follows in order to produce the exact profiling of the individual threads of the grinding worm.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

1. A method for grinding a gear or a gear-shaped profile with a non-equidistant toothing or profiling using a multi-thread grinding worm, in which the grinding worm is subjected to a dressing process prior to grinding, wherein during dressing of the grinding worm a dressing tool is brought into engagement with the grinding worm, wherein the dressing tool is designed as a multi-groove dressing roll which has several dressing surfaces extending around the axis of the dressing roll, which dressing surfaces are tooth-shaped in radial section, wherein at least three of the dressing surfaces are unevenly spaced from each other along the axis of the dressing roll and/or wherein at least two of the dressing surfaces differ from each other in their shape in radial section.

2. The method according to claim 1, wherein several of the dressing surfaces, preferably all dressing surfaces, are at least temporarily in simultaneous engagement with the grinding worm during dressing.

3. The method according to claim 1, wherein the tooth-shaped dressing surfaces have a tooth thickness at a reference diameter, wherein at least two of the tooth thicknesses are of different sizes.

4. The method according to claim 1, wherein the tooth-shaped dressing surfaces have a pitch at a reference diameter, wherein at least two of the pitches are of different sizes.

5. The method according to claim 1, wherein the tooth-shaped dressing surfaces have a maximum radial height, wherein at least two of the heights are of different sizes.

6. The method according to claim 1, wherein the tooth-shaped dressing surfaces have a flank angle, wherein at least two of the flank angles are of different sizes.

7. The method according to claim 1, wherein all tooth thicknesses are different and/or that all pitches are different and/or that all heights are different and/or that all flank angles are different.

8. The method according to claim 3, wherein the difference between the largest and smallest tooth thickness is at least 0.05 mm, preferably at least 0.1 mm, and particularly preferably at least 0.2 mm.

9. The method according to claim 4, wherein the difference between the largest and smallest pitch is at least 0.05 mm, preferably at least 0.1 mm, and particularly preferably at least 0.2 mm.

10. The method according to claim 1, wherein the ratio of the number of teeth of the gear or the gear-shaped profile and the number of threads of the grinding worm to be dressed is an integer.

11. A dressing tool for dressing a multi-thread grinding worm for grinding a gear or a gear-shaped profile with a non-equidistant toothing or profiling for carrying out the method according to claim 1 wherein the dressing tool is designed as a multi-groove dressing roll, which has several dressing surfaces running around the axis of the dressing roll, which dressing surfaces are tooth-shaped in radial section, wherein at least three of the dressing surfaces, preferably all dressing surfaces, are unevenly spaced from each other along the axis of the dressing roll and/or wherein at least two of the dressing surfaces, preferably all dressing surfaces, differ from each other in their shape in radial section.

12. The dressing tool according to claim 11, wherein the tooth-shaped dressing surfaces have a tooth thickness at a reference diameter, and wherein at least two of the tooth thicknesses are of different sizes, wherein preferably the difference between the largest and smallest tooth thickness is at least 0.05 mm, preferably at least 0.1 mm, and particularly preferably at least 0.2 mm.

13. The dressing tool according to claim 11, wherein the tooth-shaped dressing surfaces have a pitch at a reference diameter, and wherein at least two of the pitches are of different sizes, wherein preferably the difference between the largest and smallest pitch is at least 0.05 mm, preferably at least 0.1 mm, and particularly preferably at least 0.2 mm.

14. The dressing tool according to claim 11, wherein the tooth-shaped dressing surfaces have a maximum radial height, wherein at least two of the heights are of different sizes.

15. The dressing tool according to claim 11, wherein the tooth-shaped dressing surfaces have a flank angle, wherein at least two of the flank angles are of different sizes.

16. The dressing tool according to claim 11, wherein the dressing surfaces have a diamond coating.
